(19) United States
(12) Patent Application Publication
(10) Pub. No.: US 2026/0260101 A1
(43) Pub. Date: Sep. 3, 2026

(54) MODEL QUANTIZATION METHOD AND APPARATUS, ELECTRONIC DEVICE, AND STORAGE MEDIUM

(71) Applicants: Beijing Zitiao Network Technology Co., Ltd., Beijing (CN); LEMON INC., Grand Cayman (KY)

(72) Inventors: Huixia LI, Beijing (CN); Yuexiao MA, Beijing (CN); Xiawu ZHENG, Beijing (CN); Xuefeng XIAO, Beijing (CN); Rui WANG, Los Angeles, CA (US); Shilei WEN, Beijing (CN); Xin PAN, Beijing (CN); Fei CHAO, Beijing (CN); Rongrong JI, Beijing (CN)

(21) Appl. No.: 19/159,776

(22) PCT Filed: Mar. 12, 2024
(86) PCT No.: PCT/CN2024/081245

§ 371 Date: Aug. 26, 2025

(30) Foreign Application Priority Data
Mar. 13, 2023 (CN) 202310259827.3

(51) Int. Cl. G06N 3/0495; G06N 3/0464

(52) U.S. Cl. CPC G06N 3/0495; G06N 3/0464

(57) ABSTRACT

Embodiments of the present disclosure disclose a model quantization method and apparatus, an electronic device, and a storage medium. The method includes: determining a capability metric of a respective module in a model to be quantized, wherein the capability metric of the respective module indicates capability of the respective module in data processing; determining a difference value in capability metrics between adjacent modules in modules and determining an adjacent module pair to be joined according to the difference value; and performing joint quantization on the determined adjacent module pair to be joined in the model to be quantized.

### CROSS-REFERENCE TO RELATED APPLICATION(S)

The present application claims priority to Chinese Patent Application No. 202310259827.3, entitled “MODEL QUANTIZATION MET HOD AND APPARATUS, ELECTRONIC DEVICE, AND STORAGE MEDIUM”, filed with the China National Intellectual Property Administration on Mar. 13, 2023, which is incorporated herein by reference in its entirety.

### FIELD

Embodiments of the present disclosure relate to the field of computer technology, and in particular, to a model quantization method and apparatus, an electronic device, and a storage medium.

### BACKGROUND

Post-training quantization is one of common methods for neural network quantization, which can map floating-point weights and activations in a trained neural network to low-bit fixed-point numbers to achieve neural network compression. Since the post-training quantization method does not include a process of quantization training, a quantized model obtained through the post-training quantization method exhibits a significant accuracy gap compared to a full-precision model.

### SUMMARY

Embodiments of the present disclosure provide a model quantization method and apparatus, an electronic device, and a storage medium, which may improve the quantization accuracy of a post-training quantization method.

In a first aspect, embodiments of the present disclosure provide a model quantization method, including:
determining a capability metric of a respective module in a model to be quantized, wherein the capability metric of the respective module indicates capability of the respective module in data processing;
determining a difference value in capability metrics between adjacent modules in modules and determining an adjacent module pair to be joined according to the difference value; and
performing joint quantization on the determined adjacent module pair to be joined in the model to be quantized.

In a second aspect, embodiments of the present disclosure further provide a model quantization apparatus, including:
a capability metric assessment module, configured to determine a capability metric of a respective module in a model to be quantized, wherein the capability metric of the respective module indicates capability of the respective module in data processing;
a joint information determination module, configured to determine a difference value in capability metrics between adjacent modules in modules and determining an adjacent module pair to be joined according to the difference value; and
a joint quantization module, configured to perform joint quantization on the determined adjacent module pair to be joined in the model to be quantized.

In a third aspect, embodiments of the present disclosure further provide an electronic device. The electronic device includes:
one or more processors; and
a storage means, configured to store one or more programs, where
the one or more programs, when executed by the one or more processors, cause the one or more processors to implement the model quantization method according to any one of the embodiments of the present disclosure.

In a fourth aspect, embodiments of the present disclosure further provide a storage medium including computer-executable instructions. The computer-executable instructions, when executed by a computer processor, are used to perform the model quantization method according to any one of the embodiments of the present disclosure.

According to the technical solution in the embodiments of the present disclosure, the capability metrics of each module in the model to be quantized are determined, where the capability metrics of each module represent the capability of the module in data processing; the difference value in the capability metrics between the adjacent modules in the modules is determined, and the adjacent module pairs to be joined are determined according to the difference values; and the joint quantization is performed on the adjacent module pairs to be joined in the model to be quantized.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic diagram of a relationship between a final quantization loss and a maximum quantization loss in a post-training quantization process;

FIG. 2 is a schematic flowchart of a model quantization method according to embodiments of the present disclosure;

FIG. 3 is a block diagram of a quantization process of a model quantization method according to embodiments of the present disclosure;

FIG. 4 is a block diagram of a process of determining capability metrics of each module in a scenario without data in a model quantization method according to embodiments of the present disclosure;

FIG. 5 is a block diagram of a process of determining capability metrics of each module in a scenario with data in a model quantization method according to embodiments of the present disclosure;

FIG. 6 is a schematic diagram of a structure of a model quantization apparatus according to embodiments of the present disclosure; and

FIG. 7 is a schematic diagram of a structure of an electronic device according to embodiments of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not limiting, and those skilled in the art should understand that unless otherwise explicitly specified in the context, the modifiers should be understood as “one or more”.

It should be understood that data (including but not limited to the data itself, and data acquisition, or usage) involved in the technical solutions should comply with the requirements of corresponding laws and regulations, and relevant stipulations.

Experimental findings reveal that in a quantization process based on a post-training quantization method, a phenomenon that a trained model experiences significant oscillations in quantization loss may occurs. To explore the correlation between quantization loss oscillations and quantization accuracy, the following research is conducted:

Firstly, a trend in quantization loss variation in a case of module equivalence is proposed: given a pre-trained model and input data, if two adjacent modules in the pre-trained model are equivalent, the quantization loss of the latter module is greater than that of the former module.

The trend in quantization loss variation may be understood as the quantization loss monotonically increasing due to a cumulative effect under the condition of adjacent module equivalence. However, in a practical pre-trained model, the above condition of “adjacent module equivalence” is difficult to satisfy. For example, variations in hyper parameters of some convolutional layers may make adjacent modules no longer equivalent. When the adjacent modules are not equivalent, it may be considered that the capability of the module in data processing (hereinafter referred to as “module capability”) has changed.

Then, the following trend in quantization loss variation is derived: if the module capability of the latter module between the adjacent modules is significantly greater than that of the former module, the quantization loss will decrease. Conversely, if the module capability of the latter module is less than that of the former module, the quantization loss cumulative effect may be exacerbated based on an original quantization loss cumulative effect.

The further obtained variation trend may indicate that the phenomenon of quantization loss oscillations occurring in the post-training quantization process is caused by differences in module capacities. Moreover, the greater the difference in capacities between two adjacent modules, the more pronounced the quantization loss oscillations. In a practical application model, a latter module typically needs to output a low-dimensional vector with a higher compression degree, namely, there is often a trend where the latter module has a smaller capability than a former module, and therefore the quantization loss oscillations usually increase a maximum quantization loss in a case of equivalent module capacities.

Subsequently, a large number of quantization losses in the post-training quantization process are randomly sampled, a final quantization loss and the maximum quantization loss are statistically analyzed, and a scatter plot is generated.

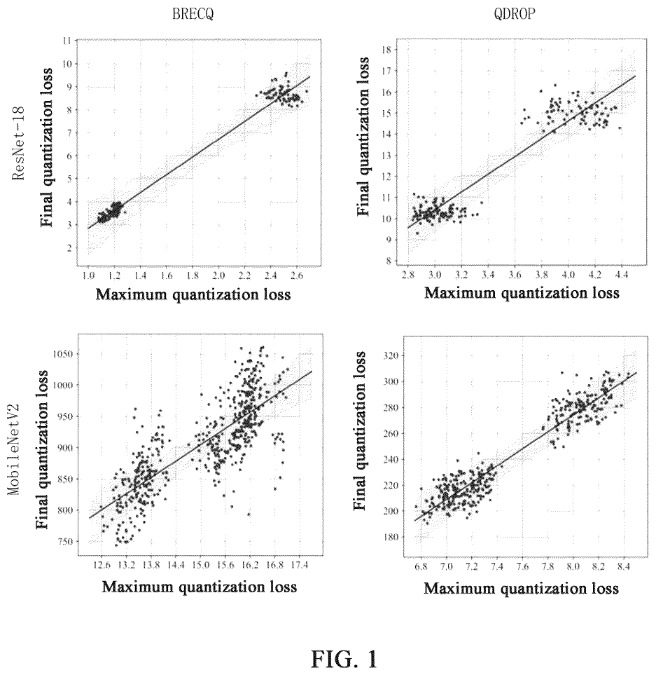

Exemplarily, FIG. 1 is a schematic diagram of a relationship between a final quantization loss and a maximum quantization loss in a post-training quantization process. Referring to FIG. 1, for a trained mobile network model (e.g., a MobileNetV2 model in FIG. 1) and a residual network (a ResNet-18 model in FIG. 1), when a method for “increasing limits of post-training quantization by block reconstruction” (denoted as BRECQ in FIG. 1) and a method for “randomly dropping quantization for low-bit post-training quantization” (denoted as QDROP in FIG. 1) are respectively adopted in the post-training quantization process, a positive correlation between the final quantization loss and the maximum quantization loss is presented. Assuming that a model to be quantized includes L modules, the positive correlation may be described by the following formula:

$$Loss ( {W}_{L} , {X}_{L} ) ∝ max ( Loss ( {W}_{1} , {X}_{1} ) , … , Loss ( {W}_{L - 1} , {X}_{L - 1} ) ) ,$$

where Loss(Wᵢ, Xᵢ) may represent a quantization loss of an it module after quantization in the model to be quantized.

Namely, based on data statistics, there is a positive correlation between the final quantization loss and the maximum quantization loss in the post-training quantization process.

In summary, differences in module capacities within the model to be quantized may lead to the quantization loss oscillations. The quantization loss oscillations may amplify the maximum quantization loss, subsequently increasing the final quantization loss. Since the final quantization loss is highly correlated with post-quantization accuracy, it may be concluded that the quantization loss oscillations in the post-training quantization process impair the quantization accuracy.

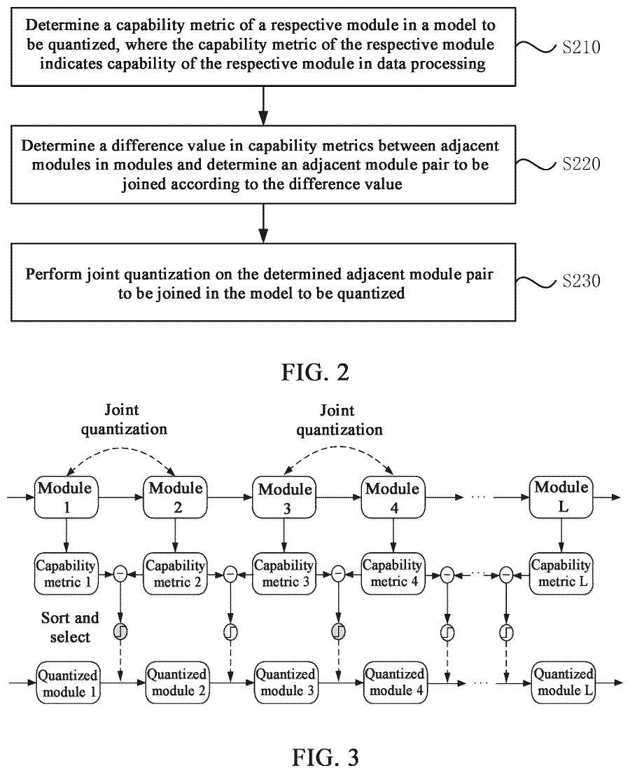

Based on the above research, embodiments of the present disclosure provide a model quantization method, which may improve the quantization accuracy of a post-training quantization method. FIG. 2 is a schematic flowchart of a model quantization method according to embodiments of the present disclosure. These embodiments of the present disclosure are applicable to a case of model quantization based on a post-training quantization method. The method may be performed by a model quantization apparatus. The apparatus may be implemented in the form of software and/or hardware, and may be configured in an electronic device, such as a computer.

As shown in FIG. 2, the model quantization method according to these embodiments may include:

S210: Determine a capability metric of a respective module in a model to be quantized, where the capability metric of the respective module indicates capability of the respective module in data processing.

In these embodiments of the present disclosure, the model to be quantized may be a pre-trained model; and each module in the model to be quantized may be composed of at least one convolutional layer, and may be configured to perform at least one data processing operation.

Before performing post-training quantization on the model to be quantized, the module capability of each module in the model may be first assessed. The module capability of each module may be assessed from different dimensions. For example, the module capability may be assessed from the intrinsic dimension of the module (e.g., a structure and a parameter quantity). For another example, the module capability may be assessed from the dimension of module data processing (e.g., accuracy and speed). Assess dimensions and access methods for each dimension may be preset according to a specific model to be quantized.

It may be considered that results of assessing the module capability of each module from different dimensions may all belong to the capability metrics of the module. Moreover, in a case that the capability metrics of each module include capability metrics from at least two dimensions, the capability metrics from the at least two dimensions may also be fused (e.g., weighted fusion), to determine final capability metrics of the module, thereby more accurately representing the module capability of the module.

Exemplarily, FIG. 3 is a block diagram of a quantization process of a model quantization method according to embodiments of the present disclosure. Referring to FIG. 3, the model to be quantized may be composed of a module 1 to a module L which are sequentially connected. By assessing capability metrics of each module, capability metrics from 1 to L may be respectively obtained.

S220: Determine a difference value in capability metrics between adjacent modules in modules and determine an adjacent module pair to be joined according to the difference value.

Exemplarily, referring to FIG. 3 again, the adjacent modules in the modules in FIG. 3 may include: a module 1 and a module 2, the module 2 and a module 3, . . . , and a module L−1 and a module L.

In these embodiments, the difference value in the capability metrics between the adjacent modules may be respectively calculated, such as subtracting a smaller value from a larger value in capability metric, or subtracting the capability metric of the latter module from the capability metric of the former module, which is not limited herein.

Then, the adjacent module pairs to be joined are determined according to the difference values, which may include: taking absolute values of the difference values; and then determining the adjacent module pairs to be joined according to the absolute values. For example, an adjacent module pair to be joined may be composed of two adjacent modules with the maximum absolute value. For another example, an adjacent module pair to be joined may be composed of two adjacent modules with the absolute value greater than a preset value. It may be considered that at least one adjacent module pair may be included.

By determining the adjacent module pairs to be joined according to the difference values of the capability metrics, the adjacent module pair with a great difference in module capability may be selected, namely, the adjacent module pair causing significant quantization loss oscillations may be selected, which is beneficial to reduce the quantization loss oscillations in the post-training quantization process.

In some optional implementations, the determining the adjacent module pair to be joined according to the difference value may include: determining a preset number of adjacent module pairs to be joined according to a descending order of difference values.

Firstly, the absolute values of the difference values may be taken to ensure that the difference values are positive numbers. Then, the absolute values of the difference values are sorted in descending order from largest to smallest. Finally, a preset number of adjacent module pairs to be joined may be determined by ranking the difference values in descending order. For example, an adjacent module pair formed by two adjacent modules corresponding to a first preset number of difference values may be used as the adjacent module pair to be joined. For another example, an adjacent module pair corresponding to a preset number of difference values randomly selected from difference values greater than an arrangement median may be used as the adjacent module pair to be joined. The preset number may be set according to experience or experiments, and by controlling the number of the adjacent module pairs, optimal quantization accuracy may be achieved.

In addition, the adjacent module pair to be joined may be determined by constructing the following formula:

$${arg max}_{m} {\sum }_{l = 1}^{L - 1} {( {CM}_{l} - {CM}_{l + 1} )}^{2} {m}_{l} + λ {e}^{- {( m \cdot 1 - k )}^{2}} ,$$

where a solution goal of the above formula

$${arg max}_{m} ( \cdot )$$

is to find a value of m that maximizes a result value, where m represents a binary vector of a length L−1, and mₗ represents a value of an t element in m. When the value is 0, it may be considered that an l^{th} module and an (l+1)^{th} module in the model to be quantized do not form an adjacent module pair to be joined; and when the value is 1, it may be considered that the l^{th} module and an (l+1)^{th} module in the model to be quantized form an adjacent module pair to be joined. CM₁ and CMₗ₊₁ represent capability metrics of the l^{th} module and an (l+1)^{th} module in the model to be quantized respectively, and the model to be quantized may a total of L modules, where l represents a vector of the same length as m with all elements being 1, k represents a preset number, and A represents a preset regularization term scale factor. Based on the above formula, adjacent module pairs to be joined corresponding to the largest first k squared differences may be determined at once, which is highly efficient.

In these optional implementations, by selecting the adjacent modules corresponding to the first preset number of difference values with the larger absolute values to form adjacent module pairs to be joined, the quantization loss oscillations in the post-training quantization process are further reduced.

S230: Perform joint quantization on the determined adjacent module pair to be joined in the model to be quantized.

Exemplarily, referring to FIG. 3 again, assuming that by sorting the difference values in descending order and selecting the adjacent module pairs corresponding to the first preset number of larger difference values (abbreviated as sorting and selection in FIG. 3), the adjacent module pair formed by the module 1 and the module 2, and the adjacent module pair formed by the module 3 and the module 4, are determined as the adjacent module pairs to be joined in the model to be quantized. In the post-training quantization process, the determined adjacent module pair formed by the module 1 and the module 2 may be jointly quantized as a whole module, and the determined adjacent module pair formed by the module 3 and the module 4 may also be jointly quantized as a whole module.

Taking the model to be quantized in FIG. 3 as an example, the step of performing joint quantization on the determined adjacent module pairs to be joined in the model to be quantized may include: first, jointly quantizing the module 1 and the module 2 as a whole to obtain a quantized module 1 and a quantized module 2 after joint quantization; and then, jointly quantizing the module 3 and the module 4 as a whole to obtain the quantized module 3 and the quantized module 4 after joint quantization. Subsequently, a module 5, a module 6, . . . and a module L may be quantized one by one until the quantization of all modules is completed, thereby finishing the post-training quantization process of the model to be quantized. According to an existing module quantization method, module quantization may be performed based on module input data and output data.

In these embodiments of the present disclosure, by performing joint quantization on the adjacent module pairs with large capability metric differences, the quantization loss oscillations in the post-training quantization process can be reduced, thereby improving the quantization accuracy of post-training quantization.

In some optional implementations, if there are overlapping modules in the adjacent module pairs to be joined, the step of performing joint quantization on the determined adjacent module pair to be joined in the model to be quantized may include: determining each module in the adjacent module pair to be joined to which each overlapping module belongs as a target module corresponding to each overlapping module; determining, based on a continuity of a positional sequence of overlapping modules in the model to be quantized, a respective target module group according to the target module corresponding to each overlapping module; and jointly quantizing modules in the respective target module group.

There may be at least one overlapping module in the adjacent module pairs to be joined. Taking the model to be quantized in FIG. 3 as an example, assuming that the adjacent module pairs to be joined include an adjacent module pair 1 to be joined composed of the module 1 and the module 2, an adjacent module pair 2 to be joined composed of the module 2 and the module 3, an adjacent module pair 3 to be joined composed of the module 3 and the module 4, an adjacent module pair 4 to be joined composed of the module 5 and the module 6, and an adjacent module pair 5 to be joined composed of the module 6 and the module 7. Therefore, the overlapping modules in the adjacent module pairs to be joined include the module 2, the module 3, and the module 6. Correspondingly, the modules (i.e., the module 1, the module 2, and the module 3) in the adjacent module pair 1 and the adjacent module pair 2 containing the module 2 may be used as the target modules corresponding to the module 2. The modules (i.e., the module 2, the module 3, and the module 4) in the adjacent module pair 2 and the adjacent module pair 3 containing the module 3 may be used as the target modules corresponding to the module 3. The modules (i.e., the module 5, the module 6, and the module 7) in the adjacent module pair 4 and the adjacent module pair 5 containing the module 6 may be used as the target modules corresponding to the module 6.

A sequence of data processing for the overlapping modules in the model to be quantized may be considered as a positional sequence in the model to be quantized. For example, the positional sequence of the module 2 which is the overlapping module may be considered as 2, and the positional sequence of the module 3 which is the overlapping module may be considered as 3. The continuity of the positional sequence may include positional sequence continuity and positional sequence discontinuity, and there may be at least two overlapping modules in the overlapping modules which are continuous in positional sequence. Exemplarily, assuming that the overlapping modules include the module 2, the module 3, the module 4, and the module 6, the positional sequence of the module 2, the module 3, and the module 4 in the model to be quantized is continuous, and the module 6 has a discontinuous positional sequence with the module 2, the module 3, and the module 4 in the model to be quantized.

The determining, based on the continuity of a positional sequence of the overlapping modules in the model to be quantized, a target module group according to a target module corresponding to each overlapping module includes at least one of the following: in response to at least two overlapping modules having a continuous positional sequence in the model to be quantized, merging target modules corresponding to the at least two overlapping modules to obtain a target module group; and in response to a current overlapping module having a discontinuous positional sequence with other overlapping modules in the model to be quantized, forming the target module group based on a target module corresponding to the current overlapping module.

Exemplarily, assuming that the overlapping modules with the continuous positional sequence in the model to be quantized include the module 2 and the module 3, the target module corresponding to the module 2 and the target module corresponding to the module 3 may be merged, namely, the module 1, the module 2, and the module 3 are merged with the module 2, the module 3, and the module 4 to obtain a target module group composed of the module 1, the module 2, the module 3, and the module 4.

Exemplarily, assuming that the module 6 which is the overlapping module has a discontinuous positional sequence with other overlapping modules other than the module itself in the model to be quantized, target modules (i.e., the module 5, the module 6, and the module 7) corresponding to the module 6 may form a target module group.

The jointly quantizing the modules in each target module group may include: jointly quantizing all modules in the target module group as a whole. For example, when the target module group is composed of the module 1, the module 2, the module 3, and the module 4, the module 1, the module 2, the module 3, and the module 4 may be jointly quantized as a whole to respectively obtain a quantized module 1, a quantized module 2, a quantized module 3, and a quantized module 4 after quantization, which are respectively taken as final quantization results for the module 1, the module 2, the module 3, and the module 4.

In these optional implementations, the target module groups including different numbers of modules may be determined based on continuity of the positional sequence of the overlapping modules in the model to be quantized, and joint quantization may be performed on the modules in the target module groups, so that joint quantization of the modules is more flexible, thereby reducing the quantization loss oscillations in the post-training quantization process from a global dimension, and improving the quantization accuracy.

In some optional implementations, the step of performing joint quantization on the adjacent module pairs in the model to be quantized may include: performing the joint quantization on the determined adjacent module pair to be joined in the model to be quantized based on a preset batch of sample data.

In a practical quantization process, there is a case that a data volume of the sample data is large, and in this case, the sample data may be used for model quantization in batches. Studies show that the batch size of sample data in each batch is related to the quantization accuracy, and increasing the batch size may reduce an approximation error of an optimization objective expectation. Therefore, increasing the batch may improve the quantization accuracy to a certain extent. Meanwhile, after the batch is increased to a certain extent, the improvement in quantization accuracy will be subject to diminishing marginal returns. Therefore, in these optional implementations, a suitable batch (i.e., a preset batch) of sample data may be pre-selected to jointly quantize the determined adjacent module pairs to be joined in the model to be quantized, in order to achieve optimal quantization accuracy.

According to the technical solution in these embodiments of the present disclosure, the capability metrics of each module in the model to be quantized are determined, where the capability metrics of each module represent the capability of the module in data processing; the difference value in the capability metrics between the adjacent modules in the modules is determined, and the adjacent module pairs to be joined are determined according to the difference values; and the joint quantization is performed on the adjacent module pairs to be joined in the model to be quantized. In the process of quantizing the model based on the post-training quantization method, the adjacent module pairs to be joined are determined according to the difference values in the capability metrics of the modules in the model, and the joint quantization is performed on the adjacent modules in the quantization process, thereby reducing the difference in the capability metrics of the modules to be quantized, reducing the quantization loss oscillations, and improving the quantization accuracy.

These embodiments may be combined with various optional solutions in the model quantization method according to the above embodiment. The model quantization method according to these embodiments provides a detailed description of determination of the capability metrics of the modules in different scenarios.

In the model quantization method according to this embodiment, assessment of the capability metrics may be performed from the dimension of the modules in a scenario without data. Namely, the step of determining capability metrics of each module in a model to be quantized may include:
determining, in response to the respective module satisfying a preset condition, the capability metric of the respective module according to a parameter quantity and a bit width of the respective module, where the parameter quantity and the bit width of the respective module are positively correlated with a capability metric of a corresponding module.

The scenario without data may refer to a scenario where the model to be quantized does not require sample data processing to measure the capability metrics of each module in the model. The parameter quantity of the module includes, for example, the number of parameters such as a weight value and an activation value of each network layer in the module; and the bit width of the module may refer to a data width of each parameter, such as 32 bits and 16 bits. Based on the experience and the experiments, the capability of the module in data processing is significantly influenced by the parameter quantity and the bit width of the module. Usually, the larger the parameter quantity and the bit width, the stronger the module capability.

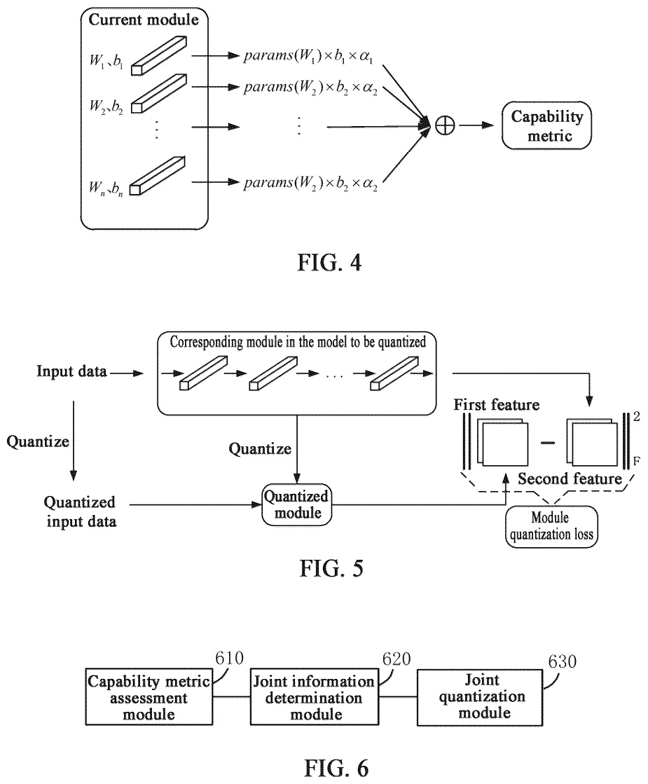

Exemplarily, FIG. 4 is a block diagram of a process of determining capability metrics of each module in a scenario without data in a model quantization method according to embodiments of the present disclosure. As shown in FIG. 4, in some implementations, the capability metrics of each module may be calculated based on the following formula:

$$ModCap = {\sum }_{i = 1}^{n} params ( {W}_{i} ) \times {b}_{i} \times {α}_{i}$$

where ModCap represents a capability metric; i represents an i^{th} convolutional layer in the current module, and there may be a total of n convolutional layers in the current module; W₁ represents a parameter of the it convolutional layer, and params(Wᵢ) is a function for determining a parameter quantity of the it convolutional layer; bᵢ represents a bit width of the i^{th} convolutional layer; and αᵢ∈[1, +∞) is a preset scale factor.

However, some other factors also influence the module capability, and the impact of these factors on the module capability is difficult to quantify, such as whether an intermediate layer of the module has a residual connection input, and the number of groups in the module convolutional layer. The existence of these factors makes it uncertain to determine the capability metrics of the module. Therefore, in these embodiments, prerequisites for calculating the capability metrics are limited. Specifically, in a case that each module satisfies the preset condition, the capability metrics of each module may be determined according to the parameter quantity and the bit width of each module. The preset condition may be preset according to the experience or the experiments, such as a condition that each module needs to satisfy in the aspects of a network structure and the number of network layers.

In a case that each module satisfies the preset condition in the scenario without data, the capability metrics of each module are directly calculated by using the parameter quantity and the bit width of each module, thereby achieving high capability metric determining efficiency.

In some optional implementations, the preset condition includes that the number of convolutional layers in the various modules is the same. The step of determining adjacent module pair to be joined according to the difference value may include: determining an adjacent module pair with a largest difference value as the adjacent module pair to be joined; and sorting difference values in a descending order, and in response to sequentially determining that no overlapping module exists between an adjacent module pair corresponding to a difference value and the determined adjacent module pair to be joined, determining the adjacent module pair corresponding to the difference value as the adjacent module pair to be joined, until a number of the determined adjacent module pairs to be joined reaches a preset number.

The number of convolutional layers in the various modules is the same, which may mean that hyper parameters of the convolutional layers corresponding to the various modules, except for a kernel size and a channel number, are all identical. Under the preset condition, the various modules may be referred to as topologically homogeneous. Since in the process of joint quantization of the plurality of modules as a whole, there is an implicit process of first jointly quantizing two initial modules and then jointly quantizing the combined module and a next module, under the premise of topological homogeneity, if there are overlapping modules between the adjacent modules, the combined module and the next module will no longer be topologically homogeneous, which violates the premise of the topological homogeneity.

Therefore, in these optional implementations, no overlapping modules between the determined adjacent module pairs are allowed. On this basis, the process of determining adjacent module pair to be joined may include: first taking absolute values of the difference values to ensure that the difference values are positive numbers; then, arranging the absolute values of the difference values in descending order from largest to smallest, and using an adjacent module pair ranking in the first (i.e., the largest difference value) as an adjacent module pair to be joined; then, sequentially determining target difference values from the difference values in a sequence from front to back, and determining adjacent module pairs corresponding to the target difference values as adjacent module pairs to be joined when there is no overlapping module between the adjacent module pairs corresponding to the target difference values and the determined adjacent module pair to be joined; and stopping a process of selecting the adjacent module pairs to be joined until the number of the adjacent module pairs to be joined reaches a preset number.

Exemplarily, assuming that under the premise of topological homogeneity, the absolute values of the difference values are ranked in descending order as 10, 9, 8, 7, . . . , these difference values respectively correspond to the adjacent module pairs including the module 1 and the module 2, the module 2 and the module 3, the module 5 and the module 6, the module 7 and the module 8, . . . , and the preset number is 3.

Therefore, the process of determining adjacent module pairs to be joined may include: using the adjacent module pair (i.e., the module 1 and the module 2) corresponding to the largest difference value (i.e., the difference value is 10) as the adjacent module pair 1 to be joined; then, sequentially determining that there is an overlapping module (i.e., the module 2) between the adjacent module pair (i.e., the module 2 and the module 3) corresponding to the difference value 9 and the determined adjacent module pair 1 to be joined, and not using the adjacent module pair corresponding to the difference value 9 as the adjacent module pair to be joined; then, sequentially determining that there is no overlapping module between the adjacent module pair (i.e., the module 5 and the module 6) corresponding to the difference value 8 and the determined adjacent module pair 1 to be joined, and determining the adjacent module pair corresponding to the difference value 8 as the adjacent module pair 2 to be joined; and continuing to determine that there is no overlapping module between the adjacent module pair (i.e., the module 7 and the module 8) corresponding to the difference value 7, the determined adjacent module pair 1 to be joined and the determined adjacent module pair 2 to be joined, and determining the adjacent module pair corresponding to the difference value 7 as the adjacent module pair 3 to be joined. In this case, the number of the determined adjacent module pairs to be joined reaches the preset number 3, so that the process of determining the adjacent module pairs to be joined can be stopped.

In these optional implementations, when determining the adjacent module pair to be joined under the preset condition that the modules need to satisfy the topological homogeneity, no overlapping module is allowed between the adjacent module pairs to be joined, in order to avoid violating the premise of the topological homogeneity and ensure the reasonable selection of adjacent module pairs.

In addition, according to another model quantization method according to this embodiment, capability metrics may be assessed from the dimension of module data processing in a scenario with data. Namely, the step of determining capability metrics of each module in a model to be quantized may include:
performing initial quantization on the model to be quantized module by module based on sample data; determining a module quantization loss of the respective module in the model to be quantized according to a first feature output by the respective module initially quantized and a second feature output by the corresponding module in the model to be quantized; and determining the capability metric of the respective module in the model to be quantized according to the module quantization loss, where the module quantization loss is inversely correlated with the capability metric of the respective module in the model to be quantized..

The scenario with data may refer to a scenario where the model to be quantized requires sample data processing, such as first performing one-time initial quantization based on the sample data. The initial quantization process may include a process of quantizing each module of the model to be quantized.

Exemplarily, FIG. 5 is a block diagram of a process of determining capability metrics of each module in a scenario with data in a model quantization method according to embodiments of the present disclosure. As shown in FIG. 5, a quantized module in FIG. 5 may be considered as any one of initially quantized modules, and correspondingly, features output by the quantized module are referred to as first features. Features output by a module (i.e., a corresponding module in the model to be quantized) used to obtain the quantized module in the model to be quantized in FIG. 5 may be referred to as the second features. A loss between the first features and the second features may be calculated based on an existing feature loss determination algorithm to obtain a module quantization loss of a corresponding module in the model to be quantized. For example, in FIG. 5, a second-order norm loss between the first features and the second features may be calculated to obtain a module quantization loss of a corresponding module in the model to be quantized. Similarly, the module quantization loss of each module in the model to be quantized may be obtained in the same manner.

If the module quantization loss is larger, it may be considered that the module capability of the corresponding module in the model to be quantized is smaller. An inverse correlation between the module quantization loss and capability metrics of a second module may be preset. Correspondingly, according to the inverse correlation, the capability metrics of the second module may be determined based on the module quantization loss.

In the scenario with data, the capability metrics of the module may be determined using the quantization loss of the module. In this case, overlapping modules may exist in the determined adjacent module pair, thereby achieving a globally optimal solution for joint quantization and improving the quantization accuracy.

According to the technical solution in these embodiments of the present disclosure, determination of the capability metrics of the modules in different scenarios are described in detail. In a case that each module satisfies the preset condition in the scenario without data, the capability metrics of each module are directly calculated by using the parameter quantity and the bit width of each module, thereby achieving high capability metric determining efficiency. In the scenario with data, the capability metrics of the module may be determined using the quantization loss of the module. In this case, overlapping modules may exist in the determined adjacent module pair, thereby achieving the globally optimal solution for joint quantization and improving the quantization accuracy. In addition, the model quantization method according to these embodiments of the present disclosure and the model quantization method according to the above embodiments belong to the same disclosure concept, and for technical details not described in detail in these embodiments, reference may be made to the above embodiment. The same technical features have the same beneficial effects in these embodiments and the above embodiment.

FIG. 6 is a schematic diagram of a structure of a model quantization apparatus according to embodiments of the present disclosure. The model quantization apparatus according to these embodiments is applicable to a case of model quantization based on a post-training quantization method.

As shown in FIG. 6, the model quantization apparatus according to these embodiments of the present disclosure may include:
a capability metric assessment module 610, configured to determine a capability metric of a respective module in a model to be quantized, where the capability metric of the respective module indicates capability of the respective module in data processing;
a joint information determination module 620, configured to determine a difference value in capability metrics between adjacent modules in modules and determining an adjacent module pair to be joined according to the difference value; and
a joint quantization module 630, configured to perform joint quantization on the determined adjacent module pair to be joined in the model to be quantized.

In some optional implementations, the capability metric assessment module may be configured to:
determine, in response to the respective module satisfying a preset condition, the capability metric of the respective module according to a parameter quantity and a bit width of the respective module,
where the parameter quantity and the bit width of the respective module are positively correlated with a capability metric of a corresponding module.

In some optional implementations, the capability metric assessment module may be further configured to:
perform initial quantization on the model to be quantized module by module based on sample data;
determine a module quantization loss of the respective module in the model to be quantized according to a first feature output by the respective module initially quantized and a second feature output by the corresponding module in the model to be quantized; and
determine the capability metric of the respective module in the model to be quantized according to the module quantization loss,
where the module quantization loss is inversely correlated with the capability metric of the respective module in the model to be quantized.

In some optional implementations, the joint information determination module may be configured to:
determine a preset number of adjacent module pairs to be joined according to a descending order of difference values.

In some optional implementations, the preset condition includes that the number of convolutional layers in the various modules is the same, and the joint information determination module may be configured to:
determine an adjacent module pair with a largest difference value as the adjacent module pair to be joined; and
sort difference values in a descending order, and in response to sequentially determining that no overlapping module exists between an adjacent module pair corresponding to a difference value and the determined adjacent module pair to be joined, determine the adjacent module pair corresponding to the difference value as the adjacent module pair to be joined, until a number of the determined adjacent module pairs to be joined reaches a preset number.

In some optional implementations, the joint quantization module may be configured to:
determine each module in the adjacent module pair to be joined to which each overlapping module belongs as a target module corresponding to each overlapping module;
determine, based on a continuity of a positional sequence of overlapping modules in the model to be quantized, a respective target module group according to the target module corresponding to each overlapping module; and
jointly quantizing modules in the respective target module group.

In some optional implementations, the joint quantization module may be configured for at least one of the following:
in response to at least two overlapping modules having a continuous positional sequence in the model to be quantized, merging target modules corresponding to the at least two overlapping modules to obtain a target module group; and
in response to a current overlapping module having a discontinuous positional sequence with other overlapping modules in the model to be quantized, forming the target module group based on a target module corresponding to the current overlapping module.

In some optional implementations, the joint quantization module may be configured to:
perform the joint quantization on the determined adjacent module pair to be joined in the model to be quantized based on a preset batch of sample data.

The model quantization apparatus according to these embodiments of the present disclosure may perform the model quantization method according to any embodiment of the present disclosure, and has the corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

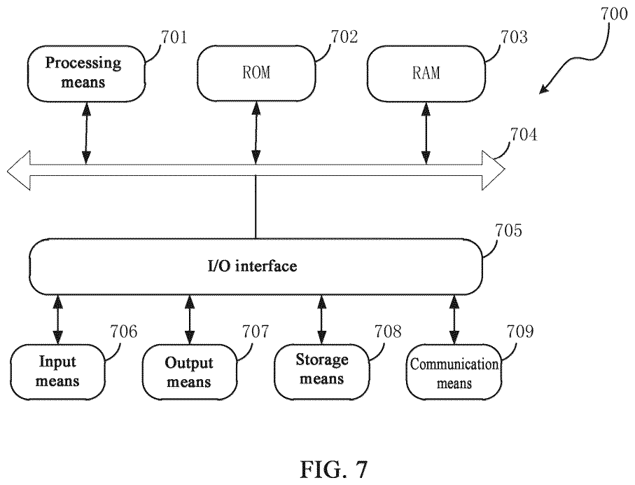

Referring to FIG. 7 as below, FIG. 7 illustrates a schematic diagram of a structure of an electronic device (e.g., a terminal device or a server in FIG. 7) 700 suitable for implementing embodiments of the present disclosure. The terminal device in these embodiments of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle terminal (e.g., a vehicle navigation terminal), and fixed terminals such as a digital TV and a desktop computer. The electronic device shown in FIG. 7 is merely an example, and should not impose any limitation on the function and scope of use of the embodiments of the present disclosure.

As shown in FIG. 7, the electronic device 700 may include a processing means (e.g., a central processing unit and a graphics processing unit) 701 that may perform various suitable actions and processing according to a program stored in a read-only memory (ROM) 702 or a program loaded from a storage means 708 into a random access memory (RAM) 703. The RAM 703 further stores various programs and data required for the operation of the electronic device 700. The processing means 701, the ROM 702, and the RAM 703 are connected to one another through a bus 704. An input/output (I/O) interface 705 is also connected to the bus 704.

Typically, the following apparatuses may be connected to the I/O interface 705: an input means 706 including, for example, a touch screen, a touch pad, a keyboard, a mouse, a camera, a microphone, an accelerometer, and a gyroscope; an output means 707 including, for example, a liquid crystal display (LCD), a speaker, and a vibrator; the storage means 708 including, for example, a magnetic tape and a hard drive; and a communication apparatus 709. The communication apparatus 709 may allow the electronic device 700 to be in wireless or wired communication with other devices for data exchange. Although FIG. 7 shows the electronic device 700 having various apparatuses, it should be understood that it is not required to implement or have all of the shown apparatuses. It may be an alternative to implement or have more or fewer apparatuses.

In particular, the above process described with reference to the flowcharts according to the embodiments of the present disclosure may be implemented as a computer software program. For example, embodiments of the present disclosure include a computer program product, which includes a computer program carried on a non-transitory computer-readable medium, where the computer program includes program code for performing the method shown in the flowchart. In these embodiments, the computer program may be downloaded and installed from the network through the communication apparatus 709, or installed from the storage means 708, or installed from the ROM 702. The computer program, when executed by the processing means 701, performs the above functions defined in the model quantization method according to these embodiments of the present disclosure.

The electronic device according to these embodiments of the present disclosure and the model quantization method according to the above embodiments belong to the same inventive concept. For the technical details not exhaustively described in these embodiments, reference may be made to the above embodiments, and these embodiments and the above embodiments have the same beneficial effects.

Embodiments of the present disclosure provide a computer storage medium, having a computer program stored therein. The program, when executed by a processor, implements the model quantization method according to the above embodiments.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM) or a flash, an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hyper text transfer protocol (HTTP), and may also be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to:
determine capability metrics of each module in a model to be quantized, where the capability metrics of each module represent the capability of the module in data processing; determine a difference value in the capability metrics between adjacent modules in the modules and determine adjacent module pairs to be joined according to the difference values; and perform joint quantization on the determined adjacent module pairs to be joined in the model to be quantized.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowchart and the block diagram in the accompanying drawings illustrate the possibly implemented system architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The names of the unit and the module do not limit the unit and the module in certain cases.

Herein, the functions described above may be at least partially executed by one or more hardware logic components. For example, without limitation, exemplary hardware logic components that can be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, a model quantization method is provided, comprising:
determining a capability metric of a respective module in a model to be quantized, wherein the capability metric of the respective module indicates capability of the respective module in data processing;
determining a difference value in capability metrics between adjacent modules in modules and determining an adjacent module pair to be joined according to the difference value; and
performing joint quantization on the determined adjacent module pair to be joined in the model to be quantized.

According to one or more embodiments of the present disclosure, a model quantization method is provided, further comprising:
in some optional implementations, determining the capability metric of the respective module in the model to be quantized comprises:
determining, in response to the respective module satisfying a preset condition, the capability metric of the respective module according to a parameter quantity and a bit width of the respective module,
where the parameter quantity and the bit width of the respective module are positively correlated with a capability metric of a corresponding module.

According to one or more embodiments of the present disclosure, a model quantization method is provided, further including:
in some optional implementations, determining the capability metric of the respective module in the model to be quantized comprises:
performing initial quantization on the model to be quantized module by module based on sample data;
determining a module quantization loss of the respective module in the model to be quantized according to a first feature output by the respective module initially quantized and a second feature output by the corresponding module in the model to be quantized; and
determining the capability metric of the respective module in the model to be quantized according to the module quantization loss,
where the module quantization loss is inversely correlated with the capability metric of the respective module in the model to be quantized.

According to one or more embodiments of the present disclosure, a model quantization method is provided, further comprising:
in some optional implementations, determining the adjacent module pair to be joined according to the difference value comprises:
determining a preset number of adjacent module pairs to be joined according to a descending order of difference values.

According to one or more embodiments of the present disclosure, a model quantization method is provided, further comprising:
in some optional implementations, the preset condition comprises that the number of convolutional layers in the modules is the same, and determining the adjacent module pair to be joined according to the difference value comprises:
determining an adjacent module pair with a largest difference value as the adjacent module pair to be joined; and
sorting difference values in a descending order, and in response to sequentially determining that no overlapping module exists between an adjacent module pair corresponding to a difference value and the determined adjacent module pair to be joined, determining the adjacent module pair corresponding to the difference value as the adjacent module pair to be joined, until a number of the determined adjacent module pairs to be joined reaches a preset number.

According to one or more embodiments of the present disclosure, a model quantization method is provided, further comprising:
in some optional implementations, in response to an overlapping module existing in adjacent module pairs to be joined, performing the joint quantization on the determined adjacent module pair to be joined in the model to be quantized comprises:
determining each module in the adjacent module pair to be joined to which each overlapping module belongs as a target module corresponding to each overlapping module;
determining, based on a continuity of a positional sequence of overlapping modules in the model to be quantized, a respective target module group according to the target module corresponding to each overlapping module; and
jointly quantizing modules in the respective target module group.

According to one or more embodiments of the present disclosure, a model quantization method is provided, further comprising:
in some optional implementations, determining, based on the continuity of the positional sequence of the overlapping modules in the model to be quantized, the respective target module group according to the target module corresponding to each overlapping module comprises at least one of:
in response to at least two overlapping modules having a continuous positional sequence in the model to be quantized, merging target modules corresponding to the at least two overlapping modules to obtain a target module group; and
in response to a current overlapping module having a discontinuous positional sequence with other overlapping modules in the model to be quantized, forming the target module group based on a target module corresponding to the current overlapping module.

According to one or more embodiments of the present disclosure, a model quantization method is provided, further comprising:
in some optional implementations, performing the joint quantization on the determined adjacent module pair to be joined in the model to be quantized comprises:
performing the joint quantization on the determined adjacent module pair to be joined in the model to be quantized based on a preset batch of sample data.

According to one or more embodiments of the present disclosure, a model quantization apparatus is provided, comprising:
a capability metric assessment module, configured to determine a capability metric of a respective module in a model to be quantized, wherein the capability metric of the respective module indicates capability of the respective module in data processing;
a joint information determination module, configured to determine a difference value in capability metrics between adjacent modules in modules and determining an adjacent module pair to be joined according to the difference value; and
a joint quantization module, configured to perform joint quantization on the determined adjacent module pair to be joined in the model to be quantized.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

1. A model quantization method, comprising:
determining a capability metric of a respective module in a model to be quantized, wherein the capability metric of the respective module characterizes capability of the respective module in data processing;
determining a difference value in capability metrics between adjacent modules in modules;
determining an adjacent module pair to be joined according to the difference value; and
performing joint quantization on the determined adjacent module pair to be joined in the model to be quantized.

2. The method according to claim 1, wherein determining the capability metric of the respective module in the model to be quantized comprises:
determining, in response to the respective module satisfying a preset condition, the capability metric of the respective module according to a parameter quantity and a bit width of the respective module,
wherein the parameter quantity and the bit width of the respective module are positively correlated with a capability metric of a corresponding module.

3. The method according to claim 1, wherein determining the capability metric of the respective module in the model to be quantized comprises:
performing initial quantization on the model to be quantized module by module based on sample data;
determining a module quantization loss of the respective module in the model to be quantized according to a first feature output by the respective module initially quantized and a second feature output by the corresponding module in the model to be quantized; and
determining the capability metric of the respective module in the model to be quantized according to the module quantization loss,
wherein the module quantization loss is inversely correlated with the capability metric of the respective module in the model to be quantized.

4. The method according to claim 1, wherein the determining adjacent module pairs to be joined according to the difference values comprises:
determining a preset number of adjacent module pairs to be joined in descending order of the difference values.

5. The method according to claim 2, wherein the preset condition comprises that the number of convolutional layers in the modules is the same, and determining the adjacent module pair to be joined according to the difference value comprises:
determining an adjacent module pair with a largest difference value as the adjacent module pair to be joined; and
sorting difference values in a descending order, and in response to sequentially determining that no overlapping module exists between an adjacent module pair corresponding to a difference value and the determined adjacent module pair to be joined, determining the adjacent module pair corresponding to the difference value as the adjacent module pair to be joined, until a number of the determined adjacent module pairs to be joined reaches a preset number.

6. The method according to claim 1, wherein in response to an overlapping module existing in the adjacent module pair to be joined, performing the joint quantization on the determined adjacent module pair to be joined in the model to be quantized comprises:
determining each module in the adjacent module pair to be joined to which each overlapping module belongs as a target module corresponding to each overlapping module;
determining, based on a continuity of a positional sequence of overlapping modules in the model to be quantized, a respective target module group according to the target module corresponding to each overlapping module; and
jointly quantizing modules in the respective target module group.

7. The method according to claim 6, wherein determining, based on the continuity of the positional sequence of the overlapping modules in the model to be quantized, the respective target module group according to the target module corresponding to each overlapping module comprises at least one of:
in response to at least two overlapping modules having a continuous positional sequence in the model to be quantized, merging target modules corresponding to the at least two overlapping modules to obtain a target module group; and
in response to a current overlapping module having a discontinuous positional sequence with other overlapping modules in the model to be quantized, forming the target module group based on a target module corresponding to the current overlapping module.

8. The method according to claim 1, wherein performing the joint quantization on the determined adjacent module pair to be joined in the model to be quantized comprises:
performing the joint quantization on the determined adjacent module pair to be joined in the model to be quantized based on a preset batch of sample data.

9. (canceled)

10. An electronic device, comprising:
one or more processors; and
a storage, configured to store one or more programs, the one or more programs, when executed by the one or more processors, causing the one or more processors to:
determine a capability metric of a respective module in a model to be quantized, wherein the capability metric of the respective module characterizes capability of the respective module in data processing;
determine a difference value in capability metrics between adjacent modules in modules;
determine an adjacent module pair to be joined according to the difference value; and
perform joint quantization on the determined adjacent module pair to be joined in the model to be quantized.

11. A non-transitory storage medium comprising computer-executable instructions, the computer-executable instructions, when executed by a computer processor, causing a computer to:
determine a capability metric of a respective module in a model to be quantized, wherein the capability metric of the respective module characterizes capability of the respective module in data processing;
determine a difference value in capability metrics between adjacent modules in modules:
determine an adjacent module pair to be joined according to the difference value; and
perform joint quantization on the determined adjacent module pair to be joined in the model to be quantized.

12. The electronic device according to claim 10, wherein the one or more programs causing the one or more processors to determine the capability metric of the respective module in the model to be quantized cause the one or more processors to:
determine, in response to the respective module satisfying a preset condition, the capability metric of the respective module according to a parameter quantity and a bit width of the respective module,
wherein the parameter quantity and the bit width of the respective module are positively correlated with a capability metric of a corresponding module.

13. The electronic device according to claim 10, wherein the one or more programs causing the one or more processors to determine the capability metric of the respective module in the model to be quantized cause the one or more processors to:
perform initial quantization on the model to be quantized module by module based on sample data;
determine a module quantization loss of the respective module in the model to be quantized according to a first feature output by the respective module initially quantized and a second feature output by the corresponding module in the model to be quantized; and
determine the capability metric of the respective module in the model to be quantized according to the module quantization loss,
wherein the module quantization loss is inversely correlated with the capability metric of the respective module in the model to be quantized.

14. The electronic device according to claim 10, wherein the one or more programs causing the one or more processors to determine the adjacent module pair to be joined according to the difference value cause the one or more processors to:
determine a preset number of adjacent module pairs to be joined in descending order of the difference values.

15. The electronic device according to claim 12, wherein the preset condition comprises that the number of convolutional layers in the modules is the same, and the one or more programs causing the one or more processors to determine the adjacent module pair to be joined according to the difference value cause the one or more processors to:
determine an adjacent module pair with a largest difference value as the adjacent module pair to be joined;
sort difference values in a descending order, in response to sequentially determining that no overlapping module exists between an adjacent module pair corresponding to a difference value and the determined adjacent module pair to be joined, determine the adjacent module pair corresponding to the difference value as the adjacent module pair to be joined, until a number of the determined adjacent module pairs to be joined reaches a preset number.

16. The electronic device according to claim 10, wherein the one or more program causing the one or more processors to perform the joint quantization on the determined adjacent module pair to be joined in the model to be quantized cause the one or more processors to, in response to an overlapping module existing in the adjacent module pair to be joined:
determine each module in the adjacent module pair to be joined to which each overlapping module belongs as a target module corresponding to each overlapping module;
determine, based on a continuity of a positional sequence of overlapping modules in the model to be quantized, a respective target module group according to the target module corresponding to each overlapping module; and
jointly quantize modules in the respective target module group.

17. The electronic device according to claim 16, wherein the one or more program causing the one or more processors to determine, based on the continuity of the positional sequence of the overlapping modules in the model to be quantized, the respective target module group according to the target module corresponding to each overlapping module cause the one or more processors to:
in response to at least two overlapping modules having a continuous positional sequence in the model to be quantized, merge target modules corresponding to the at least two overlapping modules to obtain a target module group; and/or
in response to a current overlapping module having a discontinuous positional sequence with other overlapping modules in the model to be quantized, form the target module group based on a target module corresponding to the current overlapping module.

18. The electronic device according to claim 10, wherein the one or more programs causing the one or more processors to perform the joint quantization on the determined adjacent module pair to be joined in the model to be quantized cause the one or more processors to:
perform the joint quantization on the determined adjacent module pair to be joined in the model to be quantized based on a preset batch of sample data.

19. The medium according to claim 11, wherein the instructions causing the computer to determine the capability metric of the respective module in the model to be quantized comprise instructions causing the computer to:
determine, in response to the respective module satisfying a preset condition, the capability metric of the respective module according to a parameter quantity and a bit width of the respective module,
wherein the parameter quantity and the bit width of the respective module are positively correlated with a capability metric of a corresponding module.

20. The medium according to claim 11, wherein the instructions causing the computer to determine the capability metric of the respective module in the model to be quantized comprise instructions causing the computer to:
perform initial quantization on the model to be quantized module by module based on sample data;
determine a module quantization loss of the respective module in the model to be quantized according to a first feature output by the respective module initially quantized and a second feature output by the corresponding module in the model to be quantized; and
determine the capability metric of the respective module in the model to be quantized according to the module quantization loss,
wherein the module quantization loss is inversely correlated with the capability metric of the respective module in the model to be quantized.

21. The medium according to claim 11, wherein the instructions causing the computer to determine the adjacent module pair to be joined according to the difference value comprise instructions causing the computer to:
determine a preset number of adjacent module pairs to be joined according to a descending order of difference values.
